(19) United States
(12) Patent Application Publication
(10) Pub. No.: US 2004/0017754 A1
(43) Pub. Date: Jan. 29, 2004

(54) Tilt adjusting method and apparatus using jitter feedback

(75) Inventors: Ju-Wha Jin, Seoul (KR); Soo-Yul Jung, Gyeonggi-do (KR); Dong-Ki Hong, Gyeonggi-do (KR); Jee-Hyung Park, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG Electronics Co., Ltd., Suwon-city (KR)

(21) Appl. No.: 10/412,350

(22) Filed: Apr. 14, 2003

(30) Foreign Application Priority Data
Jul. 25, 2002 (KR) 2002-43863

(51) Int. Cl. G11B 7/00

(52) U.S. Cl. 369/53.19; 369/53.34

(57) ABSTRACT

A tilt adjusting method and apparatus use jitter feedback. The tilt adjusting apparatus includes a jitter detection unit, which detects the jitter quantity of a reproduction signal picked up by a pickup unit, a jitter data preprocessing unit, which filters the jitter quantity in a predetermined window interval unit and obtains a value of an objective function from the filtered jitter data in each predetermined time unit, and a tilt control unit, which obtains a tilt adjusting value by performing tilt control using the value of the objective function and feeds the obtained tilt adjusting value back to a tilt driving unit. According to the tilt-adjusting method and apparatus, when data on an optical disc with a tilt defect is reproduced, quantified jitter values being fed back are adjusted. By preprocessing the values in a variety of ways and using the preprocessed jitter data in tilt adjusting, the reproduction performance of an optical recording and/or reproducing apparatuses can be improved in spite of the tilt defect of the disc.

### CROSS-REFERENCE TO RELATED APPLICATIONS

This application claims the benefit of Korean Patent Application No. 2002-43863 filed Jul. 25, 2002, in the Korean Intellectual Property Office, the disclosure of which is incorporated herein by reference.

### BACKGROUND OF THE INVENTION

1. Field of the Invention

The present invention relates to a tilt adjusting method and apparatus using jitter feedback employed in an optical recording and/or reproducing apparatus, and more particularly, to a tilt adjusting method and apparatus in which jitter data to be fed back are preprocessed and the preprocessed jitter data are used in adjusting a tilt.

2. Description of the Related Art

When writing information on, and reading information from, a disc using an optical recording and/or reproducing apparatus, if the disc is bent or the pickup unit of the optical recording and/or reproducing apparatus is askew, the quality of the reproduced signal is degraded. To compensate for this degradation of a reproduced signal, a relative tilt quantity between a disc and an objective lens is measured, and a tilt is adjusted so that the measured tilt quantity can be removed. This is referred to as tilt adjusting.

FIG. 1 illustrates the structure of a prior art tilt adjusting apparatus.

Referring to FIG. 1, the conventional tilt adjusting apparatus comprises a pickup unit 20, which records information on, or reads information from, a disc 11 and which has an objective lens 21, a pickup support unit 24 (also referred to as a sled) on which the pickup unit 20 is mounted and which rotates around a fixed support point 22, a displacement sensor 26, which is installed on the bottom surface of the pickup support unit 24, a tilt driving unit 28, a tilt driving motor 30, a reproduction signal generation unit 32, a jitter detection unit 34, a tilt control unit 36, and a memory 38. The reproduction signal generation unit generates a reproduction signal corresponding to information recorded on the disc using an optical signal received by the pickup unit 20. The jitter detection unit 34 detects the jitter quantity of a reproduction signal generated in the reproduction signal generation unit 32 as shown in FIG. 2A when a tilt driving signal (FIG. 2B) is provided to the tilt driving motor 30 so that the tilt of the pickup unit 20 is controlled. The tilt control unit 36 controls a tilt degree of the pickup unit 20 by feeding the jitter quantity of the reproduction signal, detected by the jitter detection unit 34, back to the tilt driving circuit unit 40. The memory 38 stores reference tilt adjusting values. The displacement sensor 26 detects the displacement of the pickup unit 20 by measuring a light quantity detected by a light receiving device 26c, which detects a light signal that is output by a light emitting device 26b and reflected by a reflection mirror 26a.

In order to correctly reproduce a signal from an optical disc with a tilt defect, a tilt is detected by using a jitter signal and the displacement sensor 26 and then is corrected in the apparatus shown in FIG. 1, disclosed in U.S. Pat. No. 6,282,161 to the applicant of the present application.

When information on the disc is first reproduced, the apparatus shown in FIG. 1 measures a tilt value, with which the jitter quantity of a signal reproduced by the pickup unit 20 is minimized by using the displacement sensor 26 at each of the inner circumference and the outer circumference of the disc. Then, while information on the disc is being reproduced, interpolated values based on tilt values obtained from the two locations are provided to the tilt driving unit 28 so that degradation of reproduction and recording due to a tilt defect can be prevented.

However, in the technology which improves reproduction performances by feeding back jitter data when information on a tilt defect disc is reproduced, it is important how closely the jitter quantity relates to a tilt defect degree. When information is reproduced, an increase in a jitter quantity can be caused by factors other than a tilt defect. Therefore, the prior art method of simply using a jitter quantity detected by the jitter detection unit 34 cannot provide desired performance improvements.

### SUMMARY OF THE INVENTION

To solve the above problems, it is an aspect of the present invention to provide a tilt adjusting method and apparatus which appropriately preprocess fed-back jitter data for tilt adjusting.

To solve the above and/or other problems, it is another aspect of the present invention to provide a tilt adjusting method and apparatus which, using the characteristic of jitter data that jitter values are not constant during a rotation cycle of a disc and have a periodic shape having a maximum value and a minimum value, appropriately preprocess jitter data before using the jitter data for tilt adjusting, and use the preprocessed jitter data as fed-back data for tilt adjusting.

Additional aspects and advantages of the invention will be set forth in part in the description which follows and, in part, will be obvious from the description, or may be learned by practice of the invention.

According to an aspect of the present invention, a tilt adjusting method for an optical recording and/or reproducing apparatus having a pickup unit, which picks up information recorded on an optical disc, and a tilt driving unit, which adjusts the tilt degree of the pickup unit, comprises an operation of detecting the jitter quantity of a reproduction signal picked up by the pickup unit, filtering the jitter quantity detected in a predetermined window interval unit, and obtaining an objective function from the filtered jitter data in each predetermined time unit; and an operation of obtaining a tilt adjusting value by performing tilt control using the objective function, and feeding the obtained tilt adjusting value back to the tilt driving unit.

If the value of the objective function obtained in the the operation of filtering the jitter quantity of the reproduction signal picked up by the pickup unit is less than a tilt adjusting value which is stored as a constant value in advance, the tilt adjusting method may further comprise performing the operation of detecting the jitter quantity of a reproduction signal picked up by the pickup unit, and otherwise performing the operation of obtaining a tilt adjusting value by performing tilt control using the objective function and feeding the obtained tilt adjusting value back to the tilt driving unit.

It is desirable that the predetermined time unit is one revolution cycle of the outer circumference of the optical disc.

According to another aspect of the present invention, a tilt adjusting apparatus in an optical recording and/or reproducing apparatus having a pickup unit, which picks up information recorded on an optical disc, and a tilt driving unit, which adjusts the tilt degree of the pickup unit, comprises a jitter detection unit, which detects the jitter quantity of a reproduction signal picked up by the pickup unit, a jitter data preprocessing unit which filters the jitter quantity in a predetermined window interval unit and obtains an objective function from the filtered jitter data in each predetermined time unit, and a tilt control unit, which obtains a tilt adjusting value by performing tilt control using the objective function and feeds the obtained tilt adjusting value back to the tilt driving unit.

### BRIEF DESCRIPTION OF THE DRAWINGS

These and/or other aspects and advantages of the present invention will become more apparent and more readily appreciated from the following description of the embodiments, taken in conjunction with the accompanying drawings of which:

FIG. 1 illustrates the structure of a conventional tilt adjusting apparatus;

FIG. 2A-2B show examples of jitter data with respect to a tilt quantity;

FIG. 3 illustrates the structure of a tilt adjusting apparatus according to an embodiment of the present invention;

FIG. 4A-4C show examples of jitter data during a revolution of a disc; and

FIG. 5 is a flowchart showing an embodiment of a tilt adjusting method according to the present invention.

### DESCRIPTION OF THE PREFERRED EMBODIMENTS

References will now be made in detail to the present embodiments of the present invention, examples of which are illustrated in the accompanying drawings, wherein Ilike reference numerals refer to the like elements throughout. The embodiments are described below in order to explain the present invention by referring to the figures.

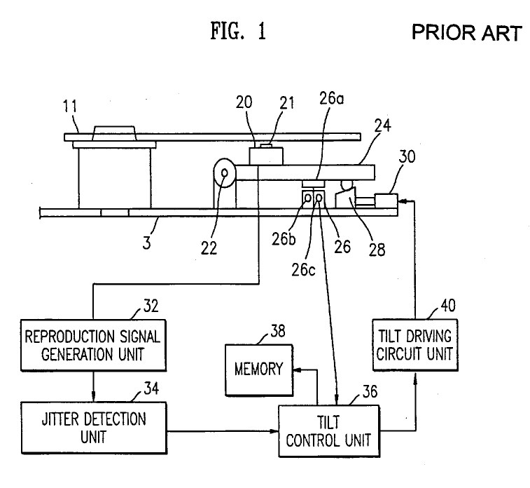

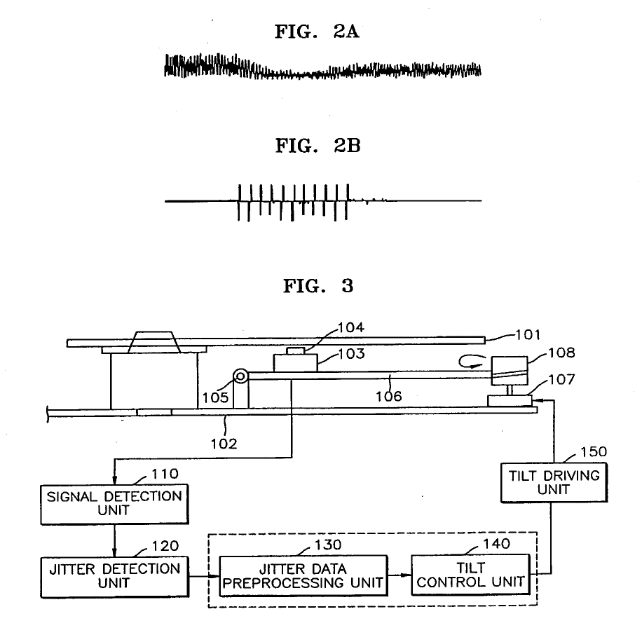

Referring to FIG. 3, a tilt adjusting apparatus according to an embodiment of the present invention comprises a pickup unit 103, which records information on, or reads information from, a disc 101 and which has an objective lens 104, a pickup support unit 106 on which the pickup unit 103 is mounted and which rotates around a fixed support point 105, a tilt motor 107, which inclines the pickup unit 103 upward or downward with respect to the fixed support point 105, and a gear unit 108, which moves the pickup support unit 106 upward and downward according to the driving direction of the tilt motor 107. However, FIG. 3 illustrates just a brief structure for a better understanding of the present invention, and other variations and modifications of this structure can be effected. Also, the tilt adjusting apparatus may include a displacement sensor for detecting the displacement of the pickup unit as shown in FIG. 1. Meanwhile, a detailed explanation of the functions and structures known to those skilled in the art will be omitted.

A signal detection unit 110 detects a reproduction signal corresponding to information recorded on the disc 101 from a light signal received by the pickup unit 103. A jitter detection unit 120 may be implemented as a phase locked loop (PLL) circuit and detects the jitter quantity from the reproduction signal. A jitter data preprocessing unit 130 determines the size of a window in a time interval when jitter data is to be filtered, and after setting a desired criterion, filters jitter data obtained through the PLL circuit during the predetermined window interval. Then, the jitter data preprocessing unit 130 detects a maximum value, a minimum value, or an average value of jitter data filtered in each predetermined window interval, with a predetermined period, preferably with a cycle of one revolution of an outer circumference of the disc 101. Here, the predetermined window size is set to less than one revolution cycle.

Also, the jitter data preprocessing unit 130 calculates an objective function F(j) by using a maximum value, a minimum value, or a weighted average value of the maximum value and the minimum value, which are previously detected, with a cycle of one revolution of the outer circumference of the disc 101, from jitter data filtered during each predetermined window interval.

A tilt control unit 140 finds a tilt adjusting value to decrease the objective function F(j) calculated in the jitter data preprocessing unit 130 by using tilt adjusting values that are stored in advance as constant values in the unit, and feeds the tilt adjusting value back to the tilt driving unit 150 so that the tilt degree of the pickup unit 103 can be controlled. That is, the tilt control unit 140 has an internal memory that stores a minimum value of the objective function F(j) and compares the calculated value of the objective function F(j) with the minimum value of the objective function F(j) stored in the memory. If the calculated value of the objective function F(j) is greater than or equal to the stored minimum value, the tilt control unit 140 finds a tilt adjusting value to decrease the value of the objective function F(j) and feeds the found tilt adjusting value back to the tilt driving unit 150 so that the tilt motor 107 is driven. If the value of the objective function F(j) is less than the stored minimum value, the tilt control unit 140 does not drive the tilt motor 107. Thus, the tilt control unit 140 controls the tilt degree of the pickup unit 103.

The tilt driving unit 150 generates a tilt driving signal corresponding to the tilt adjusting value provided by the tilt control unit 140. The tilt motor 107, which is driven by the generated tilt driving signal, is constructed so that degradation of a reproduction signal can be prevented by slanting the pickup unit 103 in the direction in which the tilt quantity is removed. Since the objective lens 104 is a part of the pickup unit 103 that moves clockwise or counterclockwise around the fixed support point 105, if the pickup support unit 106 is slanted by the gear unit 108, the objective lens 104 and the pickup support unit 106 are slanted compared to the disc 101. Accordingly, if a location where the jitter quantity detected in the jitter detection unit 120 is minimized is found by shaking the tilt of the pickup unit 103, the location is an optimal tilt adjusting value. The jitter preprocessing unit 130 and the tilt control unit 140 in the dotted line block indicate that the units may be implemented as software in a microcomputer.

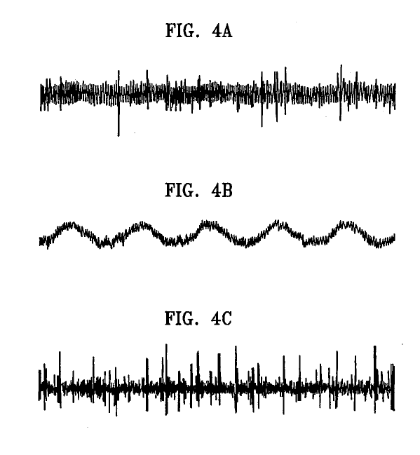

FIG. 4A shows an example of a tracking error signal according to the state of a tracking servo (not shown) following a track. FIG. 4B shows an example of jitter data output from the jitter detection unit 120 with a short time interval when a track is followed in a normal reproduction mode in which the tilt motor is not driven. These jitter data are not regular during one revolution cycle of a disc and have a periodic shape having a maximum and a minimum. FIG. 4C is an example of a signal driving the tracking actuator of the tracking servo.

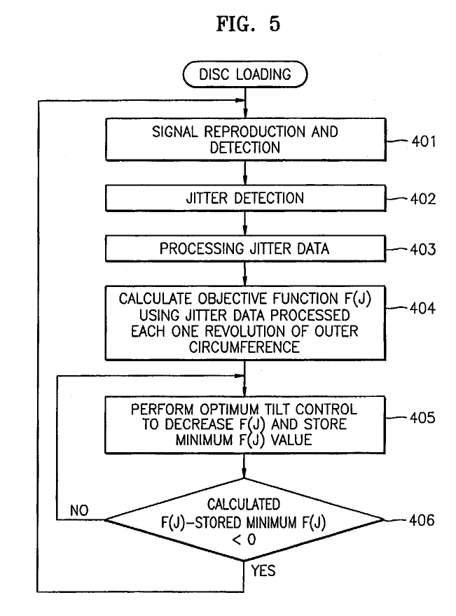

FIG. 5 is a flowchart showing an embodiment of a tilt adjusting method according to the present invention using jitter feedback, and will now be explained in relation to FIG. 3. If the disc 101 is placed adjacent to the objective lens of the pickup unit 103, the signal detection unit 110 reproduces a signal picked up by the pickup unit 103 and detects a reproduction signal in operation 401. The jitter detection unit 120 detects the jitter quantity from the reproduction signal using the PLL in operation 402.

Jitter values output from the jitter detection unit 120 with a short time interval have a maximum value and a minimum value in each cycle of one revolution of the disc 101 as shown in the example in FIG. 4B. In addition, the jitter values have a noise component. For example, even during one revolution of the disc, the jitter values change rather suddenly, and irregularly have big values that are deemed to be meaningless. Accordingly, as a correction, the jitter data preprocessing unit 130 processes jitter data in operation 403. That is, assuming that T denotes a time wherein 1 revolution of the outer circumference of a disc is performed, M (window interval) denotes the number of jitter samples Jk read by a microcomputer for updating 1 jitter value, and Δt denotes a sampling time between the microcomputer's each reading, and a number N of jitter values updated during one revolution can be obtained by the following Equation 1:

$$N = \frac{T}{Δ t} \frac{1}{M} \qquad ( 1 )$$

When a jitter value updated during a predetermined window interval is defined as \overline{J}ₜ, the jitter value \overline{J}ₜ is a filtered value obtained by a filter constructed as shown in the following Equation 2:

$${\overline{J}}_{t} = {\sum }_{k} {J}_{k} h ( t - k Δ t ) , k = 0 , 1 , … , M - 1 \qquad ( 2 )$$

The transfer function h(t) of the filter is implemented so that meaningless data are removed, detected data have a consistent meaning, and optimum coefficients are found by experimentation. Also, a low pass filter may be used for a simple implementation. Using N jitter values filtered using Equation 2 during one revolution of the outer circumference of the disc 101, a maximum value (JMax) can be obtained by the following Equation 3, a minimum value (JMin) can be obtained by the following Equation 4, or an average value (JAve) can be obtained by the following Equation 5.

$$\begin{matrix}JMax = max \{ {\overline{J}}_{t} \} , i ∈ \{ 1 , 2 , … , N & ( 3 ) \\ JMin = min \{ {\overline{J}}_{t} \} , i ∈ \{ 1 , 2 , … , N & ( 4 ) \\ JAve = \frac{{\sum }_{i = 1 , 2 , … , N} {\overline{J}}_{i}}{N} & ( 5 )\end{matrix}$$

Finally, the jitter data preprocessing unit 130 obtains the objective function F(j) which minimizes a tilt from the following Equations 6 through 8 by using jitter data processed during each revolution of the outer circumference, and the maximum value, minimum value, and average value obtained by Equations 3 through 5, in operation 404:

F(J)=JMax (6)

F(J)=JAve (7)

F(J)=α·JMax+(1−α)·JMin (8)

where α is a real number equal to or greater than 0 and equal to or less than 1.

In the tilt adjusting performed in the tilt control unit 140, the objective function F(j) defined by the maximum value of the jitter value updated during one revolution cycle according to Equation 6, or the objective function F(j) defined by the average value of the jitter value updated during one revolution cycle according to Equation 7 is selected. However, Equation 8, the weighted average value of the maximum value and minimum value of the jitter value updated during one revolution cycle, may also be selected, and leads to good results depending on the circumstances. An optimum value of tilt adjusting is a value which minimizes the objective function F(j) when the maximum value obtained by Equation 6 is used for the objective function F(j), or when the average value obtained by Equation 7 is used for the objective function F(j), or when the weighted average value obtained by Equation 8 is used for the objective function F(j).

The tilt control unit 140 performs a predetermined tilt control routine for decreasing the objective function F(j) and stores the minimum value of the objective function F(j) in operation 405. That is, finding an optimum tilt adjusting value is finding a location where jitters are minimized. The tilt control unit 140 slants the pickup unit 103 by the tilt motor 107 driven by the tilt driving signal generated by the tilt driving unit 150 according to the tilt adjusting value provided by the tilt control unit 140. If the jitter value detected by the jitter detection unit 120 increases, the pickup unit 103 is slanted in the opposite direction, and if the jitter value decreases, the pickup unit 103 is continuously slanted in the identical direction. If the jitter value increases again, the previous tilt adjusting value is restored and then a location may be found where the jitter value is minimum. Thus, by using the minimum value of the objective function F(j) obtained during each one revolution cycle, an optimum value which minimizes the jitter value is detected.

In operation 406, if the calculated value of the objective function F(j) is less than the stored minimum value of the objective function F(j), the operation 401 to reproduce a light receiving signal and detect a reproduction signal is performed, and otherwise, the operation 405 to perform the optimum tilt control routine is performed.

According to the present invention, when data on an optical disc with a tilt defect is reproduced, unadjusted quantified jitter values being fed back are not used. Instead, by processing (preprocessing) the values in a variety of ways and using the processed jitter data in tilt adjusting, the reproduction performance of, for example, a DVD player as a leading example of optical recording and/or reproducing apparatuses, can be improved in spite of the tilt detect of the disc.

Also, even when an optimum location for tilt is different at each predetermined revolution cycle, tilt is not adjusted at each location because, if it is determined that jitter data preprocessed at each revolution cycle are within a suitable scope for reproduction, tilt adjusting is not needed. Accordingly, the system is more efficient and stable.

In one embodiment, the operational steps of the method of the present invention may be implemented as computer-executable instructions stored on a computer-readable medium.

Although a few preferred embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A tilt adjusting method for an optical recording and/or reproducing apparatus having a pickup unit, which picks up information recorded on an optical disc, and a tilt driving unit, which adjusts a tilt degree of the pickup unit, the method comprising:
detecting a jitter quantity of a reproduction signal picked up by the pickup unit;
filtering the jitter quantity detected in a predetermined window interval unit, and obtaining a value of an objective function from filtered jitter data in each predetermined time unit; and
obtaining a tilt adjusting value by performing tilt control using the value of the objective function, and feeding the tilt adjusting value back to the tilt driving unit.

2. The tilt adjusting method of claim 1, further comprising:
if the value of the objective function obtained is less than a tilt adjusting value which is stored as a constant value in advance, performing the operation of detecting the jitter quantity of the reproduction signal picked up by the pickup unit, and otherwise performing the operation of obtaining the tilt adjusting value by performing tilt control using the objective function and feeding the obtained tilt adjusting value back to the tilt driving unit.

3. The tilt adjusting method of claim 2, wherein the tilt adjusting value which is stored in advance is a minimum value of the objective function.

4. The tilt adjusting method of claim 1, wherein the predetermined time unit is one revolution cycle of an outer circumference of the optical disc.

5. The tilt adjusting method of claim 1, wherein the filtering of the jitter quantity detected in the predetermined window interval unit, and obtaining the value of the objective function from filtered jitter data in each predetermined time unit, during a window interval indicating a predetermined time interval for filtering, comprises removing meaningless data, detecting a maximum value of filtered jitter data in each revolution cycle of the optical disc, and setting the objective function to a maximum value.

6. The tilt adjusting method of claim 1, wherein the filtering of the jitter quantity detected in the predetermined window interval unit, and obtaining the value of the objective function from the filtered jitter data in each predetermined time unit, during a window interval indicating a predetermined time interval for filtering, comprises removing meaningless data, detecting an average value of filtered jitter data in each revolution cycle of the optical disc, and setting the objective function to an average value.

7. The tilt adjusting method of claim 1, wherein the filtering of the jitter quantity detected in the predetermined window interval unit, and obtaining the value of the objective function from the filtered jitter data in each predetermined time unit, during a window interval indicating a predetermined time interval for filtering, comprises removing meaningless data, detecting a maximum value and a minimum value of filtered jitter data in each revolution cycle of the optical disc, and setting the objective function to a weighted average value using the maximum value and the minimum value.

8. A tilt adjusting apparatus in an optical recording and/or reproducing apparatus having a pickup unit, which picks up information recorded on an optical disc, and a tilt driving unit, which adjusts the tilt degree of the pickup unit, the apparatus comprising:
a jitter detection unit that detects the jitter quantity of a reproduction signal picked up by the pickup unit;
a jitter data preprocessing unit that filters the jitter quantity in a predetermined window interval unit and obtains a value of an objective function from the filtered jitter data in each predetermined time unit; and
a tilt control unit that obtains a tilt adjusting value by performing tilt control using the value of the objective function, and feeds the obtained tilt adjusting value back to the tilt driving unit.

9. The apparatus of claim 8, wherein the predetermined time unit is one revolution cycle of an outer circumference of the optical disc.

10. The apparatus of claim 8, wherein during a window interval indicating a predetermined time interval for filtering, the jitter data preprocessing unit removes meaningless data, detects a maximum value of filtered jitter data in each revolution cycle of the optical disc, and sets the objective function to a maximum value.

11. The apparatus of claim 10, wherein the tilt control unit obtains a tilt adjusting value with which the value of the objective function value is minimized.

12. The apparatus of claim 8, wherein during a window interval indicating a predetermined time interval for filtering, the jitter data preprocessing unit removes meaningless data, detects an average value of a predetermined number of filtered jitter data values in each revolution cycle of the optical disc, and sets the value of the objective function to an average value.

13. The apparatus of claim 12, wherein the tilt control unit obtains a tilt adjusting value with which the value of the objective function value is minimized.

14. The apparatus of claim 8, wherein during a window interval indicating a predetermined time interval for filtering the jitter data preprocessing unit removes meaningless data, detects a maximum value and a minimum value of a predetermined number of filtered jitter data values in each revolution cycle of the optical disc, and sets the value of the objective function to a weighted average value using the maximum value and the minimum value.

15. The apparatus of claim 14, wherein the tilt control unit obtains a tilt adjusting value with which the value of the objective function value is minimized.

16. The apparatus of claim 8, wherein the tilt control unit includes an internal memory that stores a minimum value of the objective function, and if the value of the objective function obtained in the jitter data preprocessing unit is less than the stored minimum value of the objective function, a tilt adjusting value is not fed back to the tilt driving unit so that the tilt driving unit is not driven.

17. A computer-readable medium having stored thereon computer-executable instructions for performing a tilt adjusting method for an optical recording and/or reproducing apparatus having a pickup unit, which picks up information recorded on an optical disc, and a tilt driving unit, which adjusts the tilt degree of the pickup unit, the computer-executable instructions comprising:
filtering a jitter quantity of a reproduction signal detected in a predetermined window interval unit;
obtaining a value of an objective function from the filtered jitter data in each predetermined time unit; and
obtaining a tilt adjusting value by performing tilt control using the value of the objective function.

18. The computer-readable medium of claim 17, wherein the computer-executable instructions further comprise:
if the value of the objective function obtained is less than a tilt adjusting value which is stored as a constant value in advance,
performing the operation of detecting the jitter quantity of the reproduction signal picked up by the pickup unit, and
otherwise performing the operation of obtaining the tilt adjusting value by performing tilt control using the objective function and feeding the obtained tilt adjusting value back to the tilt driving unit.

19. The computer-readable medium of claim 18, wherein the tilt adjusting value which is stored in advance is a minimum value of the objective function.

20. The computer-readable medium of claim 17, wherein the predetermined time unit is one revolution cycle of an outer circumference of the optical disc.

21. The computer-readable medium of claim 17, wherein the filtering of the jitter quantity detected in the predetermined window interval unit, and the obtaining of the value of the objective function from the filtered jitter data in each predetermined time unit, during a window interval indicating a predetermined time interval for filtering, comprises removing meaningless data, detecting a maximum value of the filtered jitter data in each revolution cycle of the optical disc, and setting the objective function to a maximum value.

22. The computer-readable medium of claim 17, wherein the filtering of the jitter quantity detected in the predetermined window interval unit, and obtaining the value of the objective function from the filtered jitter data in each predetermined time unit, during a window interval indicating a predetermined time interval for filtering, comprises removing meaningless data, detecting an average value of the filtered jitter data in each revolution cycle of the optical disc, and setting the objective function to an average value.

23. The computer-readable medium of claim 17, wherein the filtering of the jitter quantity detected in the predetermined window interval unit, and obtaining the value of the objective function from the filtered jitter data in each predetermined time unit, during a window interval indicating a predetermined time interval for filtering, comprises removing meaningless data, detecting a maximum value and a minimum value of the filtered jitter data in each revolution cycle of the optical disc, and setting the objective function to a weighted average value using the maximum value and the minimum value.

24. A jitter data preprocessing unit for tilt adjusting in an optical recording and/or reproducing apparatus having a pickup unit, which picks up information recorded on an optical disc, and a tilt driving unit, which adjusts the tilt degree of the pickup unit, the jitter preprocessing unit comprising:
a filtering unit that filters a jitter quantity detected in predetermined window intervals to provide filtered jitter data; and
a tilt adjusting value determining unit that obtains a value of an objective function from the filtered jitter data and sets a tilt adjusting value equal to the value of the objective function.

25. The jitter data preprocessing unit of claim 24, wherein the predetermined window interval is a predetermined time unit of one revolution cycle of an outer circumference of the optical disc.

26. The jitter data preprocessing unit of claim 24, wherein during a predetermined window interval indicating a predetermined time interval for filtering, the jitter data preprocessing unit removes meaningless data, detects a maximum value of filtered jitter data in each revolution cycle of the optical disc, and sets the value of the objective function to a maximum value.

27. The jitter data preprocessing unit of claim 26, wherein the tilt adjusting value determining unit obtains the tilt adjusting value with which the value of the objective function value is minimized.

28. The jitter data preprocessing unit of claim 24, wherein during a window interval indicating a predetermined time interval for filtering the jitter data preprocessing unit removes meaningless data, detects an average value of a predetermined number of filtered jitter data values in each revolution cycle of the optical disc, and sets the value of the objective function to an average value.

29. The jitter data preprocessing unit of claim 28, wherein the tilt adjusting value determining unit obtains the tilt adjusting value with which the value of the objective function value is minimized.

30. The jitter data preprocessing unit of claim 24, wherein during a window interval indicating a predetermined time interval for filtering, the jitter data preprocessing unit removes meaningless data, detects a maximum value and a minimum value of a predetermined number of filtered jitter data values in each revolution cycle of the optical disc, and sets the value of the objective function to a weighted average value using the maximum value and the minimum value.

31. The jitter data preprocessing unit of claim 30, wherein the tilt adjusting value determining unit obtains the tilt adjusting value with which the value of the objective function value is minimized.

32. The jitter data preprocessing unit of claim 24, wherein, if the value of the objective function obtained is less than a stored minimum value of the objective function, the tilt adjusting value determining unit that obtains the value of the objective function from the filtered jitter data and the tilt adjusting value is not modified.

33. A computer-readable medium having stored thereon computer-executable instructions for performing a tilt adjusting method for an optical recording and/or reproducing apparatus, the computer-executable instructions comprising:
filtering a jitter quantity detected in predetermined window intervals to provide filtered jitter data; and
determining a tilt adjusting value by obtaining a value of an objective function from the filtered jitter data.

34. A tilt adjusting method for an optical recording and/or reproducing apparatus having a pickup unit, which picks up information recorded on an optical disc, and a tilt driving unit, which adjusts a tilt degree of the pickup unit, the method comprising:
detecting a jitter quantity of a reproduction signal picked up by the pickup unit;
filtering the jitter quantity detected in a predetermined window interval unit, and obtaining a value of an objective function from filtered jitter data in each predetermined time unit; and
obtaining a tilt adjusting value by performing tilt control using the value of the objective function, and feeding the tilt adjusting value back to the tilt driving unit,
wherein unadjusted quantified jitter values being fed back are not utilized.
